(19) United States
(12) Patent Application Publication
(10) Pub. No.: US 2014/0139767 A1
(43) Pub. Date: May 22, 2014

(54) LIQUID CRYSTAL DISPLAY DEVICE

(71) Applicant: SAMSUNG DISPLAY CO., LTD., Yongin-City (KR)

(72) Inventors: CHANG-HUN LEE, Hwaseong-si (KR); Cheol SHIN, Hwaseong-si (KR); Seungho HONG, Gunpo-si (KR)

(73) Assignee: Samsung Display Co., Ltd., Yongin-City (KR)

(21) Appl. No.: 13/890,511

(22) Filed: May 9, 2013

(30) Foreign Application Priority Data
Nov. 19, 2012 (KR) 10-2012-0131069

(51) Int. Cl. G02F 1/1343

(52) U.S. Cl. CPC G02F 1/134363
USPC 349/33; 349/138

(57) ABSTRACT

A liquid crystal display device includes a lower substrate, an upper substrate and a liquid crystal layer. The lower substrate includes an insulating substrate, a first electrode, an insulating layer disposed on the first electrode, a second electrode and a third electrode. The first electrode is disposed on the insulating substrate and includes a first sub-electrode. The second electrode is disposed on the insulating layer and includes a second sub-electrode overlapping the first sub-electrode. The third electrode is disposed on the insulating layer and includes a third sub-electrode spaced apart from the first and second sub-electrodes.

This application claims priority to Korean Patent Application No. 10-2012-0131069, filed on Nov. 19, 2012, and all the benefits accruing therefrom under 35 USC §119, the entirety of which is hereby incorporated by reference.

### BACKGROUND

a. Field

The invention relates to liquid crystal display devices and, more particularly, to a liquid crystal display device operating in a horizontal electric field mode.

b. Description of the Related Art

A liquid crystal display device includes a lower substrate on which a thin film transistor is provided, an upper substrate on which a color filer is provided, and a liquid crystal layer disposed between the upper and lower substrates and having an anisotropic dielectric constant. The liquid crystal display device controls the alignment of liquid crystal molecules in the liquid crystal layer according to an electric field applied to the liquid crystal layer to control transmittance of light passing through the liquid crystal layer.

A liquid crystal display device may operate in a horizontal electric field mode and a vertical electric field mode. A liquid crystal display device operating in the horizontal electric field mode may include both a pixel electrode and a common electrode on a lower substrate. The alignment of liquid crystal molecules is determined by a horizontal electric field generated between the pixel electrode and the common electrode.

### SUMMARY

One or more exemplary embodiment of the invention provides a liquid crystal display device with improved visibility by reducing a mura caused by a transmittance difference in adjacent pixels at a low grayscale.

According to an exemplary embodiment of the invention, a liquid crystal display device includes a lower substrate, an upper substrate and a liquid crystal layer.

In an exemplary embodiment, the lower substrate includes an insulating layer, a first electrode, a second electrode and a third electrode.

In an exemplary embodiment, the first electrode is disposed on the insulating substrate and includes a first sub-electrode.

In an exemplary embodiment, the insulating layer is disposed on the first electrode.

In an exemplary embodiment, the second electrode is disposed on the insulating layer and includes a second sub-electrode overlapping the first sub-electrode.

In an exemplary embodiment, the third sub-electrode is disposed on the insulating layer and includes a third sub-electrode spaced apart from the first and second sub-electrodes.

In an exemplary embodiment, the second sub-electrode and the third sub-electrode may be disposed in a same layer.

In an exemplary embodiment, first-direction opposing edges of the second sub-electrode may overlap the first sub-electrode.

In an exemplary embodiment, the first electrode and the third electrode may be applied with a first voltage, and the second electrode may be applied with a second voltage different from the first voltage.

In an exemplary embodiment, a first-direction first edge of the second sub-electrode may overlap the first sub-electrode, and a first-direction opposing second end of the second sub-electrode may not overlap the first sub-electrode.

### BRIEF DESCRIPTION OF THE DRAWINGS

The invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating elements of the invention, in which:

FIG. 1 is a top plan view of an exemplary embodiment of a single pixel of a liquid crystal display device according to the invention.

FIG. 2 is a cross-sectional view taken along line I-I′ in FIG. 1.

FIGS. 3A to 3C illustrate alignment states of liquid crystal molecules according to a grayscale and transmittance of light impinging on a liquid crystal layer in an exemplary embodiment of a liquid crystal display device according to the invention.

FIG. 4 is a cross-sectional view of a lower substrate of a liquid crystal display device for explaining simulation conditions.

FIG. 5 shows a graph obtained by simulating transmittance variation depending on grayscale while changing a distance between same layer sub-electrodes in the conventional liquid crystal display device.

FIG. 6 shows a graph obtained by simulating transmittance variation depending on grayscale while changing the distance between same layer sub-electrodes in an exemplary embodiment of a liquid crystal display device according to the invention.

FIG. 7 is a top plan view of another exemplary embodiment of a single pixel of a liquid crystal display device according to the invention.

FIG. 8 is a cross-sectional view taken along line I-I′ in FIG. 7.

FIGS. 9A and 9B illustrate alignment states of liquid crystal molecules according to a grayscale and transmittance of light impinging on a liquid crystal layer in another exemplary embodiment of a liquid crystal display device according to the invention.

### DETAILED DESCRIPTION

The advantages and features of the invention and methods of achieving them will be apparent from the following exemplary embodiments that will be described in more detail with reference to the accompanying drawings. It should be noted, however, that the invention is not limited to the following exemplary embodiments, and may be implemented in various forms. Accordingly, the exemplary embodiments are provided only to disclose examples of the invention and to let those skilled in the art understand the nature of the invention.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Where a liquid crystal display device operates in a horizontal electric field mode, variation of transmittance of light passing through a liquid crystal layer is relatively large when a low grayscale image is displayed. Therefore, if a width of a pixel electrode or a width of a common electrode on a same substrate varies due to a processing error when the pixel electrode and the common electrode are formed, an unevenness defect (hereinafter referred to as “mura”) caused by a transmittance difference in respective adjacent pixels is visualized at a low grayscale.

Hereinafter, the invention will be described in detail with reference to the accompanying drawings.

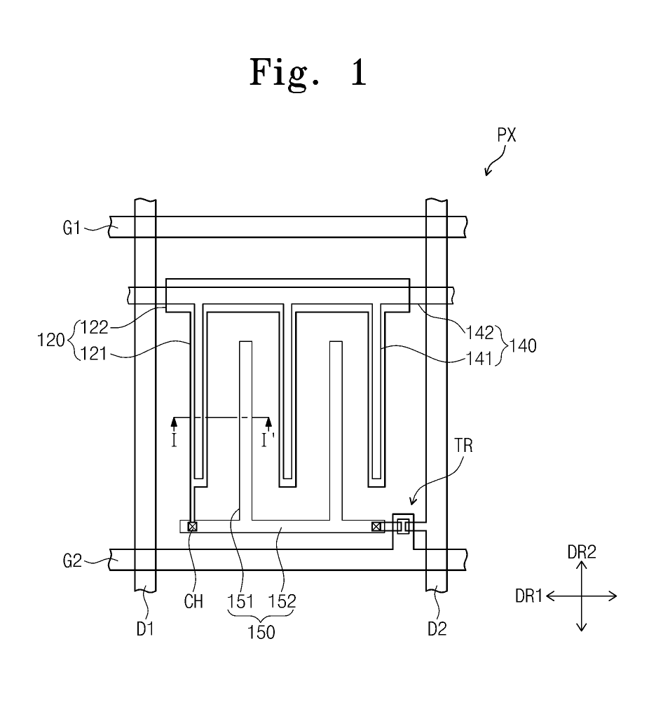

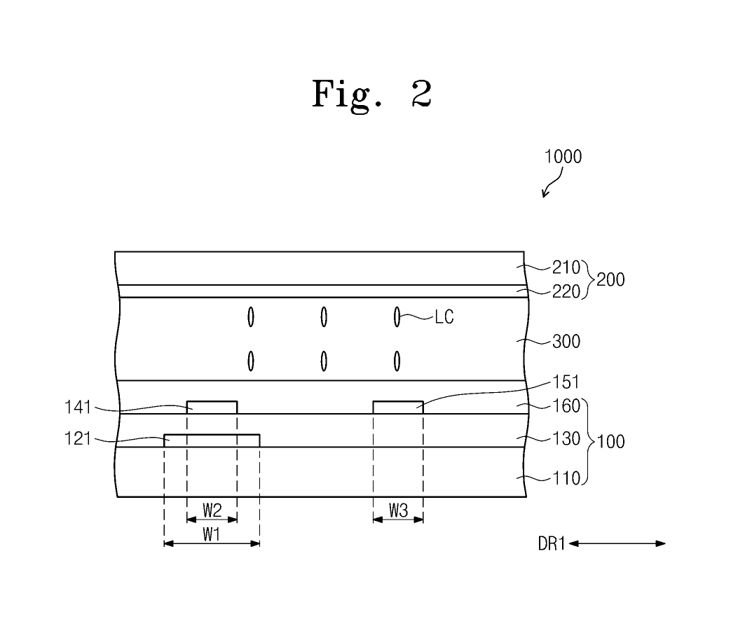

FIG. 1 is a top plan view of an exemplary embodiment of a single pixel PX of a liquid crystal display device 1000 according to the invention, and FIG. 2 is a cross-sectional view taken along line I-I′ in FIG. 1.

Referring to FIGS. 1 and 2, the liquid crystal display device 1000 includes a lower substrate 100, an upper substrate 200 and a liquid crystal layer 300.

The lower substrate 100 includes a plurality of pixel areas each including a pixel PX. Since all the pixels have the same structure, a structure of a single pixel PX will be described hereinafter.

The lower substrate 100 includes a first insulating substrate 110, a thin film transistor TR, gate lines G1 and G2, a first electrode 120, an insulating layer 130, a second electrode 140, a third electrode 150 and an alignment layer 160.

The first insulating substrate 110 may include a transparent insulating material.

The gate lines G1 and G2 are disposed on the first insulating substrate 110 and are elongated to extend in a first direction DR1. The data lines D1 and D2 are disposed on the first insulating substrate 110, are insulated from the gate lines G1 and G2, and are elongated to extend in a second direction DR2. Although not shown in the figures, an insulating material may be provided between the gate lines G1 and G2 and the data lines D1 and D2.

The thin film transistor TR is connected to the gate line G2 and the data line D2 to apply a first voltage to the first electrode 120. The thin film transistor TR may apply the first voltage to the third electrode 150 electrically connected to the first electrode 120. The first voltage may be a data voltage transferred through the data line D2.

The first electrode 120 may be a pixel electrode applied with the first voltage.

The first electrode 120 may be disposed on the first insulating substrate 110.

The first electrode 120 may include a first sub-electrode 121 and a first connection electrode 122. The first sub-electrode 121 may be provided in plurality. The plurality of first sub-electrodes 121 are disposed to be spaced apart from each other. In FIG. 1, it is shown that the first sub-electrodes 121 are spaced in apart from each other in the first direction DR1 and are elongated to extend in the second direction DR2.

However, the invention is not limited thereto. If the first sub-electrodes 121 are spaced apart from each other in the second direction DR2, they may be elongated to extend in the first direction DR1 and may be disposed to have a predetermined inclination with respect to the first direction DR1.

The first connection electrode 122 connects the plurality of first sub-electrodes 121 to each other. The first connection electrode 122 may be connected to one end of the first sub-electrodes 121 and be elongated to extend in the first direction DR1. The first sub-electrodes 121 and the first connection electrode 122 may form a single, unitary, indivisible electrode member.

The insulating layer 130 includes a transparent insulating material. The insulating layer 130 is disposed on the first electrode 120 to insulate the first electrode 120 from the second electrode 140 and the third electrode 150.

The second electrode 140 may be a common electrode applied with a second voltage such as a constant (e.g., common) voltage.

The second electrode 140 may be disposed on the insulating layer 130.

The second electrode may 140 include a second sub-electrode 141 and a second connection electrode 142.

The second sub-electrode 141 may be provided in plurality. The second sub-electrode 141 may be disposed to overlap the first sub-electrode 121.

The plurality of second sub-electrodes 141 are disposed to be spaced apart from each other. In FIG. 1, it is shown that the second sub-electrodes 141 are spaced apart from each other in the first direction DR1 and are elongated to extend in the second direction DR2.

The second connection electrode 142 connects the plurality of second sub-electrodes 141 to each other. The second connection electrode 142 may be connected to one end of the second sub-electrodes 141 and be elongated to extend in the first direction DR1. The second sub-electrodes 141 and the second connection electrode 142 may form a single, unitary, indivisible electrode member.

The third electrode 150 may be disposed in and/or on a same layer as the second electrode 140. The third electrode 150 may include a third sub-electrode 151 and a third connection electrode 152.

The third sub-electrode 151 may be provided in plurality. The third sub-electrode 151 may be disposed not to overlap the first sub-electrode 121. The third sub-electrode 151 may be disposed to be spaced apart from the second sub-electrode 141.

The plurality of third sub-electrodes 151 are disposed to be spaced apart from each other. In FIG. 1, it is shown that the third sub-electrodes 151 are spaced apart from each other in the first direction DR1 and are elongated to extend in the second direction DR2.

The third connection electrode 152 connects the plurality of third sub-electrodes 151 to each other. The third connection electrode 152 is connected to one end of the third sub-electrodes 151 and is elongated to extend in the first direction DR1.

The third sub-electrodes 151 and the third connection electrode 152 may form a single, unitary, indivisible electrode member.

The first electrode 120 is applied with the first voltage. For achieving this, the third electrode 150 receiving the first voltage from the data line D2 may be physically and/or electrically connected to the first electrode 120. The first electrode 120 and the third electrode 150 may be disposed on different layers and/or be electrically connected through a contact hole CH. Although only one contact hole CH is shown in FIG. 1, the contact hole CH may be provided in plurality.

The first sub-electrode 121 has first width W1 in the first direction DR1, the second sub-electrode 141 has second width W2 in the first direction DR2, and the third sub-electrode 151 has third width W3 in the first direction.

The first width W1 may be greater than the second width W2. In the plan view, the second sub-electrode 141 may be completely covered with the first sub-electrode 121. More specifically, in the first direction DR1, both edges of the second sub-electrode 141 may be overlapped by the first sub-electrode 121.

The first width W1 may be greater than the third width W3. The first width W1 may be smaller than a distance between the second sub-electrode 141 and the third sub-electrode 151 in the first direction DR1.

A first electric field is generated between the first sub-electrode 121 applied with the first voltage and the second sub-electrode 141 applied with the second voltage. A second electric field is generated between the second sub-electrode 141 applied with the second voltage and the third sub-electrode 151 applied with the first voltage.

An alignment state of liquid crystal molecules LC may be determined by the first electric field and the second electric field.

The first alignment layer 160 may be disposed on the second electrode 140 and the third electrode 150. The first alignment layer 160 plays a role in initially aligning a major axis of the liquid crystal molecules LC included in the liquid crystal layer 300 in a direction substantially orthogonal to the first insulating substrate 110 of the lower substrate 100.

The upper substrate 200 is disposed opposite to the lower substrate 100.

The upper substrate 200 includes a second insulating substrate 210 and a second alignment layer 220.

The second insulating substrate 210 may include a transparent insulating material.

The second alignment layer 220 is disposed on the second insulating substrate 210. The second alignment layer 220 plays the same role as the first alignment layer 160.

Although not shown in the figures, the upper substrate 200 may further include a color filter and/or a black matrix between the second insulating substrate 210 and the second alignment layer 220. The color filer serves to provide a color to light passing through the upper substrate 200, and the black matrix is provided between adjacent pixels to prevent light leakage.

The liquid crystal layer 300 is disposed between the lower substrate 100 and the upper substrate 200 and includes a plurality of liquid crystal molecules LC. The liquid crystal molecules LC may be positive in dielectric anisotropy. Thus, the major axis of the liquid crystal molecules LC is initially aligned to be substantially orthogonal to the lower substrate 100 and, when an electric field generated at the liquid crystal layer 300, is aligned substantially parallel to a direction of the electric field.

Although not shown in the figures, the liquid crystal display device 1000 may further include a polarizer. A pair of polarizers may be attached to outer surfaces of the lower substrate 100 and the upper substrate 200, respectively. The pair of polarizers may have transmission axes that are orthogonal to each other.

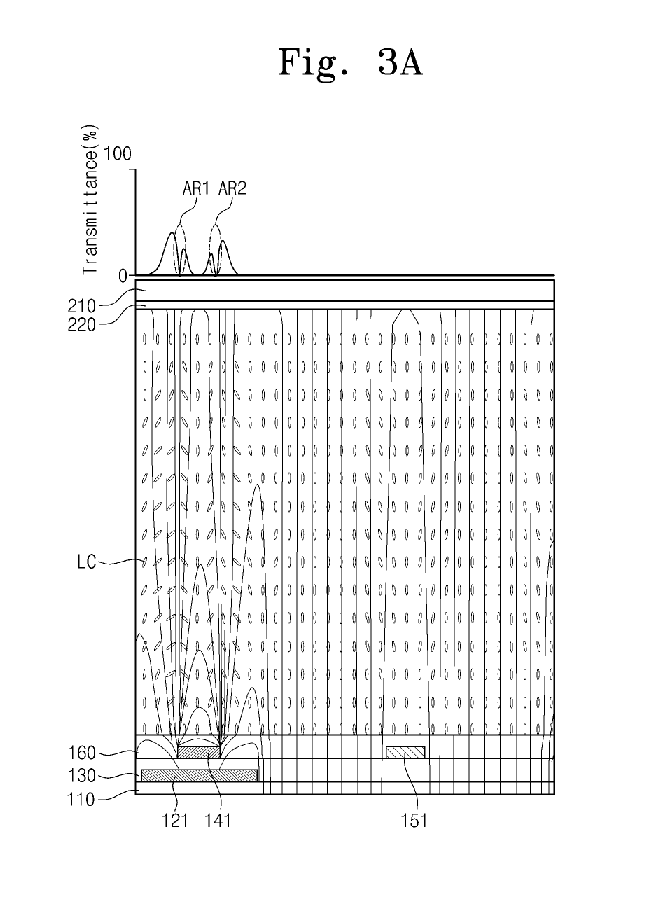

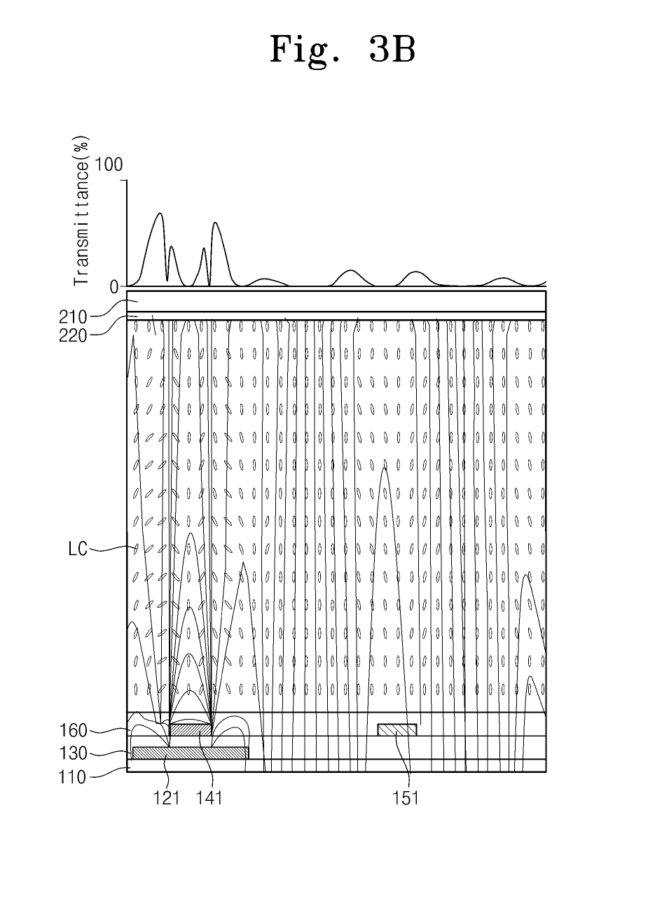

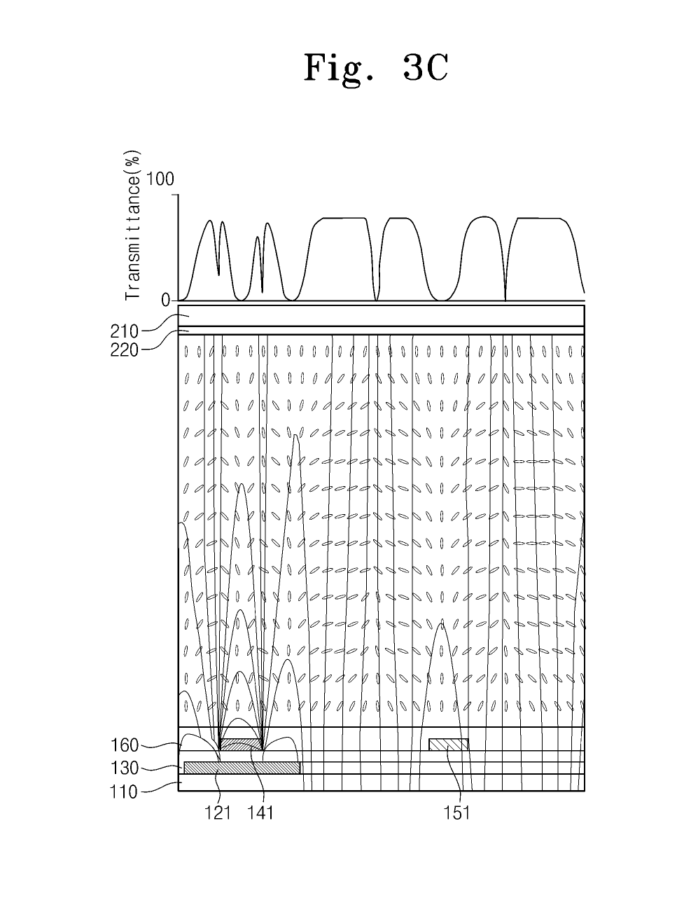

FIGS. 3A to 3C illustrate alignment states of liquid crystal molecules according to a grayscale and transmittance in percent (%) of light impinging on a liquid crystal layer in an exemplary embodiment of a liquid crystal display device according to the invention. FIG. 3A illustrates display of a low grayscale image, FIG. 3B illustrates display of a middle grayscale image displayed, and FIG. 3C illustrates display of a high grayscale image is displayed.

In FIGS. 3A to 3C, solid lines indicate iso-electric field lines.

When an image displayed on a liquid crystal display device 1000 is expressed with 64 grayscales, grayscale less than 20 grayscale, grayscales more than 20 grayscale and less than 40 grayscale, and grayscales more than 40 grayscale may be defined as low grayscales, middle grayscales and high grayscales, respectively.

When the first voltage is applied to the first electrode 120, and second voltage is applied to the second and third electrodes 140 and 150, the liquid crystal molecules LC are aligned substantially orthogonal to the lower substrate 100 and the upper substrate 200. At this point, light passing through the lower substrate 100 cannot pass through the upper substrate 200, e.g., is blocked and thus the liquid crystal display device 1000 displays black.

Referring to FIG. 3A, a voltage corresponding to a low grayscale (hereinafter referred to as “low grayscale voltage”) is applied to the first electrode 120 and the third electrode 150.

A first electric field is generated between the first sub-electrode 121 and the second sub-electrode 141, and a second electric field is generated between the second sub-electrode 141 and the third sub-electrode 151.

A cross-sectional thickness of the insulating layer 130 is much smaller than a distance between the second electrode 140 and the third electrode 150 in the first direction DR1. Thus, the distance between the first sub-electrode 121 and the second sub-electrode 141 is much smaller than that between the second sub-electrode 141 and the third sub-electrode 151.

The low grayscale voltage is set with a relatively small voltage difference, as compared to the second voltage.

Since the magnitude of an electric field is affected by a voltage difference and distance, the first electric field is greater than the second electric field. In particular, the second electric field is very small in magnitude.

When a low grayscale image is displayed, the liquid crystal molecules LC are aligned in a direction substantially horizontal (e.g., parallel) to the lower substrate 100 by the first electric field and are substantially not affected by the second electric field. That is, when the low grayscale image is displayed, the liquid crystal molecules LC are aligned in the direction substantially horizontal (e.g., parallel) to the lower substrate 100 essentially by only the first electric field.

From FIG. 3A, it would be understood that an alignment state of the liquid crystal molecules LC is changed and light transmittance increases in areas corresponding to the first sub-electrode 121 and the second sub-electrode 141.

Referring to FIGS. 3B and 3C, the alignment state of the liquid crystal molecules LC is changed not only by the first electric field but also by the second electric field as a high grayscale image is displayed from the grayscale image through the middle grayscale image. From FIGS. 3B and 3C, it would be understood that the light transmittance increases even in an area where the first sub-electrode 121 and the second sub-electrode 141 do not overlap each other.

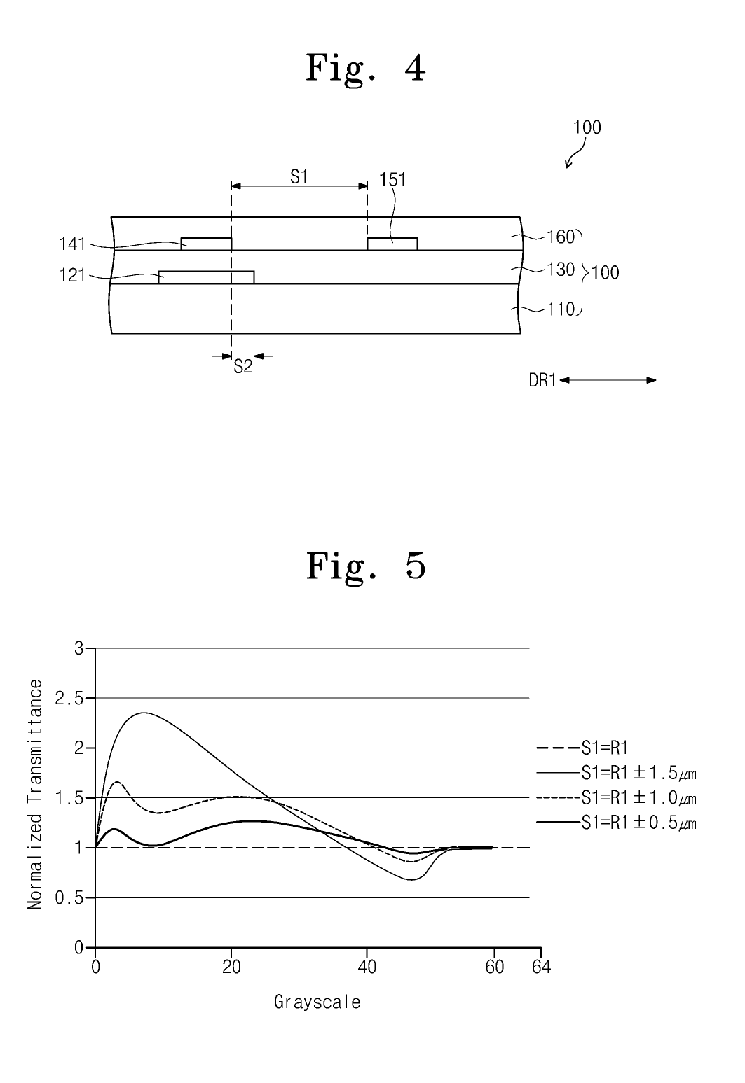

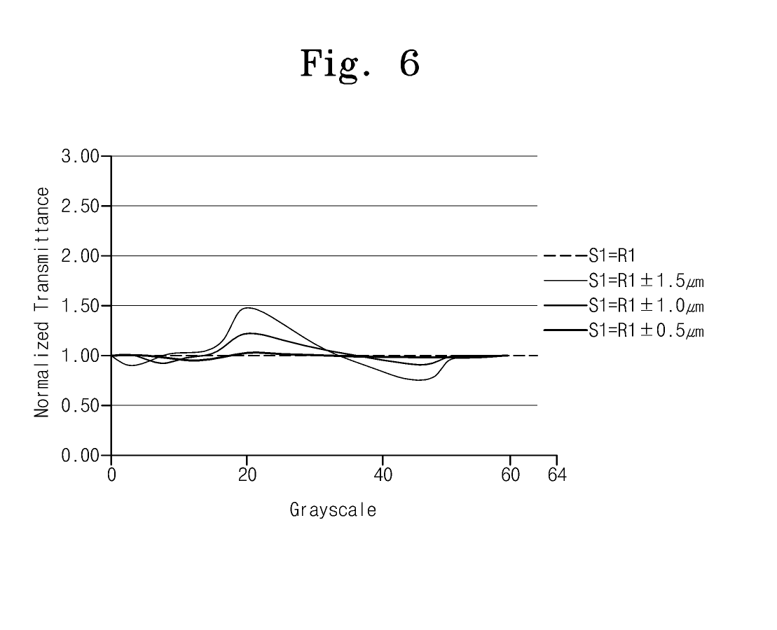

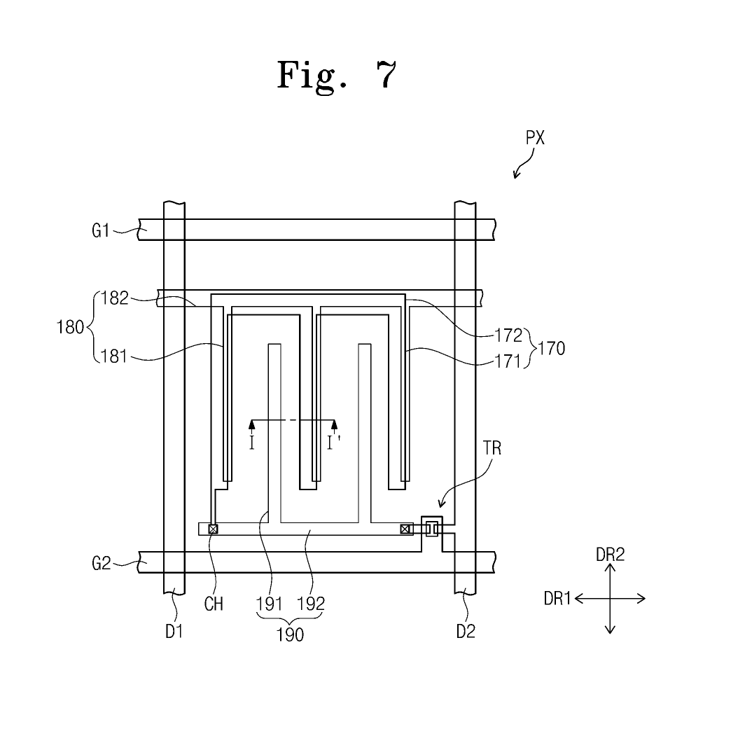

FIG. 4 is a cross-sectional view of a lower substrate for explaining simulation conditions. FIG. 5 shows a graph obtained by simulating transmittance variation depending on grayscale while changing a distance between second and third sub-electrodes in a conventional liquid crystal display device. FIG. 6 shows a graph obtained by simulating transmittance variation depending on grayscale while changing a distance between second and third sub-electrodes in an exemplary embodiment of a liquid crystal display device according to the invention.

Referring to FIG. 4, simulation parameters are S1 and S2. The parameter S1 is a distance between the second sub-electrode 141 and the third sub-electrode 151 in the first direction DR1, and the parameter S2 is a distance from one end of the first sub-electrode 121 in the first direction DR1 to a point where the first sub-electrode 141 starts to overlap the second sub-electrode 141. S2 may also be considered a distance at which one first-direction side of the first sub-electrode 121 is exposed from the second sub-electrode 141.

In an exemplary embodiment of a method of manufacturing the liquid crystal display device 1000, an etch process is performed during formation of the first to third sub-electrodes 121, 141 and 151. However, the first to third sub-electrodes 121, 141 and 151 cannot always be uniformly etched and there is some degree of a processing error. Hereinafter, an influence of an etch processing error of the first to third sub-electrodes 121, 141 and 151 on transmittance depending on grayscale will be described in detail below.

Referring to FIGS. 4 and 5, simulation conditions of a conventional liquid crystal display device were that S1 was changed while S2 was constantly kept. In particular, transmittance change depending on grayscale was simulated while a specific S1 was set as a reference distance R1 and was changed from the reference distance R1 by 0.5 micrometer (μm), 1 μm, and 1.5 micrometers (μm). For the convenience of comparison, grayscale-transmittance graphs depending on the respective conditions are normalized after being divided into grayscale-transmittance graphs having the reference distance R1.

From FIG. 5, it would be understood that there is a significant difference between transmittance where S1 equaled the reference distance R1 and transmittance where S1 is changed, at low grayscales less than 20 grayscale. In particular, since the transmittance difference at the low grayscale is directly visualized by a user, the user visualizes the transmittance difference as a mura even when the same grayscale is displayed in each adjacent pixel.

Referring to FIGS. 4 and 6, simulation conditions of an exemplary embodiment of a liquid crystal display device according to the invention were set to be identical to those of the conventional liquid crystal display device. From FIG. 6, it would be understood that there is substantially no difference between transmittance where S1 equaled the reference distance R1 and transmittance where S1 is changed.

Thus, according to the exemplary embodiment of the liquid crystal display device of the invention, a mura caused by a transmittance difference at a low grayscale is not visualized by the user even when there is some etch processing error of the first to third sub-electrodes 121, 141 and 151. It should be noted that even when there is some transmittance difference at a middle grayscale and a high grayscale, the user does not sensitively visualize the transmittance difference and thus a problem such as mura visibility occurring at the low grayscale does not occur.

In the exemplary embodiment of the liquid crystal display device 1000 according to the invention described with reference to FIGS. 1 and 2, it has been described that a data voltage is applied to the first electrode 120 and the third electrode 150, and a common voltage is applied to the second electrode 140.

However, the invention is not limited thereto and voltages applied to the first to third electrodes 120, 140, and 150 may be changed as described below for the alternative exemplary embodiments.

Firstly, a common voltage may be applied to the first electrode 120 and the third electrode 150 and a data voltage may be applied to the second electrode 140. Where the data voltage is applied to the second electrode 140, the thin film transistor TR shown in FIG. 1 is connected not to the third electrode 150, but to the second electrode 140.

Secondly, a common voltage may be applied to the first electrode 120, and a data voltage may be applied to the second electrode 140 and the third electrode 150. Where the data voltage applied to both the second and third electrodes 140 and 150, the second electrode 140 and the third electrode 150 may be electrically connected to each other. Since the second electrode 140 and the third electrode 150 are disposed in and/or on the same layer, the second and third electrodes 140 and 150 may be integrally patterned to form. In addition, the first electrode 120 is electrically insulated from the second electrode 140 and the third electrode 150. Thus, the contact hole CH shown in FIG. 1 may be omitted.

Thirdly, a data voltage may be applied to the first electrode 120, and a common voltage may be applied to the second electrode 140 and the third electrode 150. Where the data voltage is applied to only the first electrode 120, the thin film transistor TR shown in FIG. 1 is connected not to the third electrode 150 but to the first electrode 120.

The alignment of liquid crystal molecules LC is determined by the first electric field at a low grayscale, which is equivalently applied to all three of the alternative exemplary embodiments discussed above.

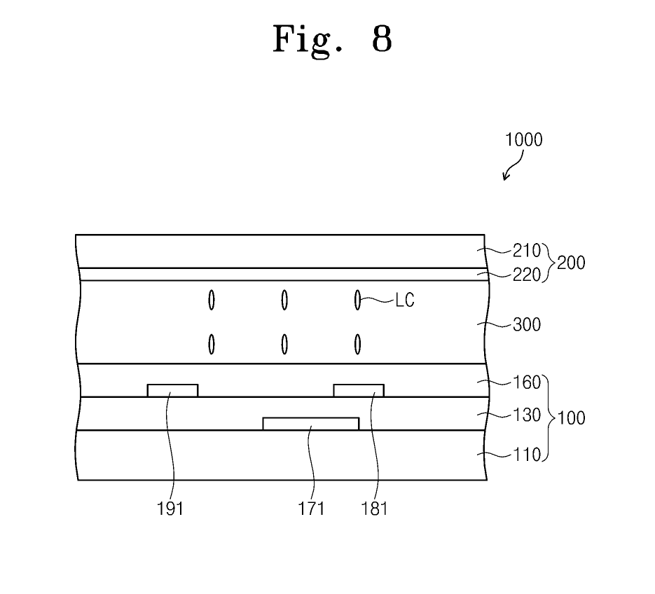

FIG. 7 is a top plan view of another exemplary embodiment of a single pixel PX of a liquid crystal display device according to the invention, and FIG. 8 is a cross-sectional view taken along line I-I′ in FIG. 7.

Except for first to third electrodes 170, 180 and 190, the another exemplary embodiment of a liquid crystal display device according to the invention is substantially the same to the previous exemplary embodiment of a liquid crystal display device according to the invention. Therefore, differences of the first to third electrodes 170, 180 and 190 will be explained and repetitive description will be omitted.

The first electrode 170 may be a pixel electrode applied with a first voltage.

The first electrode 170 may be disposed on a first insulating substrate 110.

The first electrode 170 may include a first sub-electrode 171 and a first connection electrode 172. The first sub-electrode 171 may be provided in plurality. The plurality of first sub-electrodes 171 are disposed to be spaced apart from each other. In FIG. 7, it is shown that the first sub-electrodes 171 are spaced apart from each other in a first direction DR1 and are elongated to extend in a second direction DR2.

The first connection electrode 172 connects the plurality of first sub-electrodes 171 to each other. The first connection electrode 172 may be connected to one end of the first sub-electrodes 171 and be elongated to extend in the first direction DR1.

The second electrode 180 may be disposed on the insulating layer 130. The second electrode 180 may include a second sub-electrode 181 and a second connection electrode 182.

The second sub-electrode 181 may be provided in plurality. The second sub-electrodes 181 may be disposed to overlap the first sub-electrodes 171, respectively.

The plurality of second sub-electrodes 181 are disposed to be spaced apart from each other. In FIG. 7, it is shown that the second sub-electrodes 181 are spaced apart from each other in the first direction DR1 and are elongated to extend in the second direction DR2.

The second connection electrode 182 connects the plurality of second sub-electrodes 181 to each other. The second connection electrode 182 may be connected one end of the second sub-electrode 181 and be elongated to extend in the first direction DR1.

The second electrode 170 is applied with the first voltage. For achieving this, the third electrode 190 may be physically and/or electrically connected to the first electrode 170. Although the first electrode 170 and the third electrode 190 may be disposed on different layers, they may be electrically connected through a contact hole CH. Although only one contact hole CH is shown in FIG. 1, the contact hole CH may be provided in plurality.

In the plan view, a portion of the second sub-electrode 181 overlaps the first sub-electrode 171. More specifically, in the first direction DR1, a first edge of the second sub-electrode 181 overlaps the first sub-electrode 171 and an opposing second edge thereof is not overlapped with the first sub-electrode 171. That is, a portion of the first sub-electrode 171 is exposed by the second sub-electrode 181.

The second electrode 180 may be a common electrode applied with a second voltage that is a constant voltage.

The third electrode 190 may be disposed in and/or on the same layer as the second electrode 180. The third electrode 190 may include a third sub-electrode 191 and a third connection electrode 192.

The third sub-electrode 191 may be provided in plurality. The third sub-electrode 191 may be disposed not to overlap the first sub-electrode 171. The third sub-electrode 191 may be disposed to be spaced apart from the second sub-electrode 181.

The plurality of third sub-electrodes 191 are spaced apart from each other. In FIG. 7, it is shown that the third sub-electrodes 191 are spaced apart from each other in the first direction DR1 and are elongated to extend in the second direction DR2.

The third connection electrode 192 connects the plurality of third sub-electrodes 191 to each other. The third connection electrode 192 may be connected to one end of the third sub-electrode 181 and be elongated to extend in the first direction DR1.

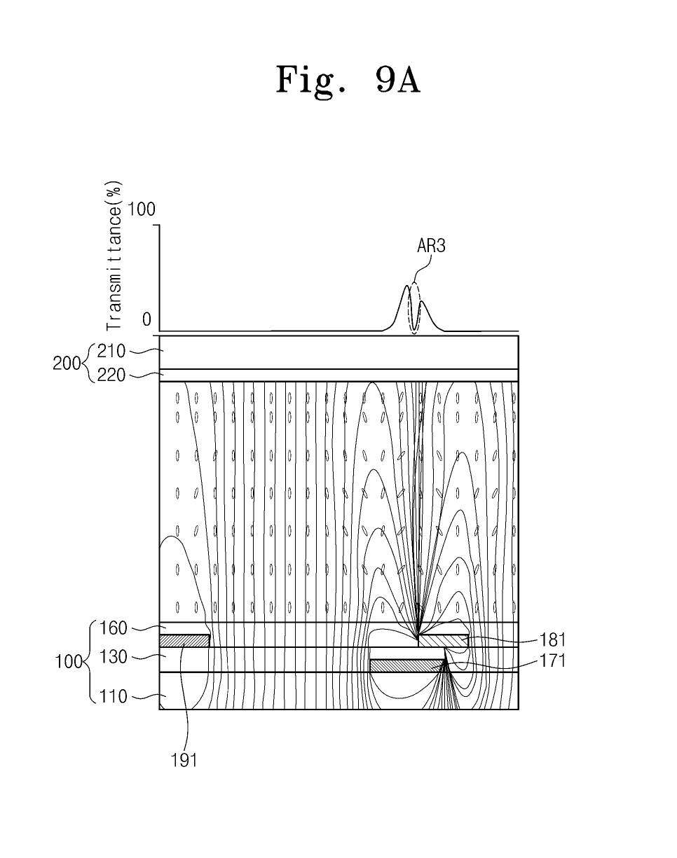

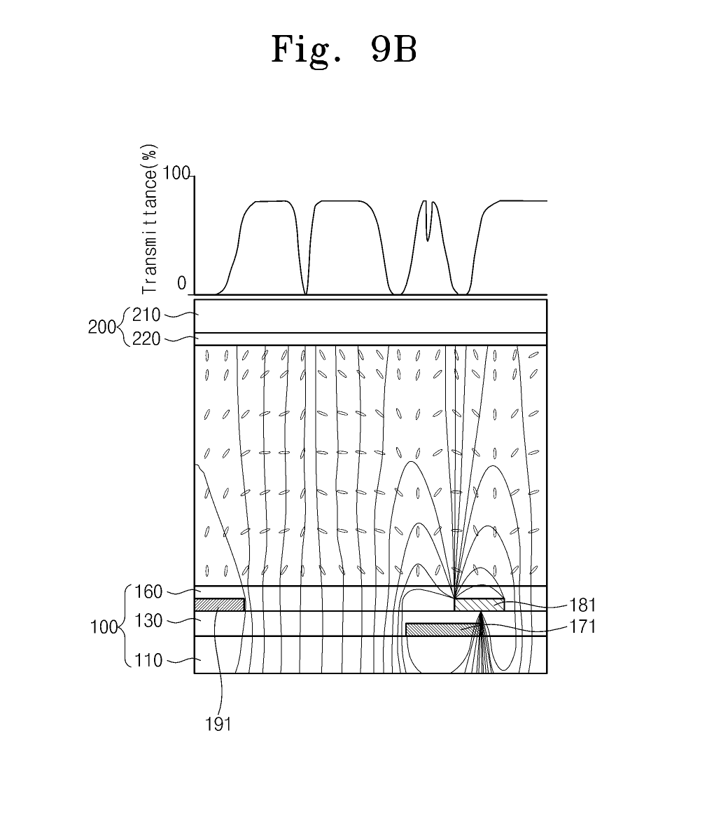

FIGS. 9A and 9B illustrate an alignment state of liquid crystal molecules according to a grayscale and transmittance in percent (%) of light impinging on a liquid crystal layer in another exemplary embodiment of a liquid crystal display device according to the invention. FIG. 9A illustrates display of a low grayscale image, and FIG. 9B illustrates display of a high grayscale image.

In FIGS. 9A and 9B, solid lines indicate iso-electric field lines.

Effects of another exemplary embodiment of a liquid crystal display device according to the invention will now be described by comparing FIGS. 3A and 9A with FIGS. 3C and 9B.

From FIG. 3A, it would be understood that the loss of light transmittance occurs in two areas AR1 and AR2 corresponding to both of opposing edges of the second sub-electrode 141. The loss of light in the two areas AR1 and AR2 occurs since liquid crystal molecules do not rotate at both of the opposing edges of the second sub-electrode 141 due to a path of an electric field generated between the first sub-electrode 121 and the second sub-electrode 141.

Referring to FIG. 3A, in the previous exemplary embodiment of a liquid crystal display device according to the invention, since both of the opposing edges of the second sub-electrode 141 overlap the first sub-electrode 121, the loss of light transmittance occurs in the two regions AR1 and AR2.

Referring to FIG. 9A, in another exemplary embodiment of a liquid crystal display device according to the invention, one edge of the second sub-electrode 181 is overlapped with the first sub-electrode 171 and the other end thereof is not overlapped with the first sub-electrode 171. Thus, the loss of light transmittance occurs in one area AR3.

The exemplary embodiment of the liquid crystal display device illustrated in FIG. 9A exhibits substantially the same effects as the previous exemplary embodiment of the liquid crystal display device illustrated in FIG. 3A while reducing the loss of light transmittance compared to the previous exemplary embodiment of the liquid crystal display device according to the invention.

Even by comparison of FIGS. 3C and 9B, it would be understood that the loss of light transmittance occurring in the exemplary embodiment of the liquid crystal display device illustrated in FIG. 9B is less than the loss of light transmittance occurring in the previous exemplary embodiment of the liquid crystal display device illustrated in FIG. 3C.

According to one or more exemplary embodiment of a liquid crystal display device described above, when a low grayscale image is displayed, visibility of a mora caused by a transmittance difference in adjacent pixels can be reduced to improve overall visibility of the liquid crystal display device. In addition, the loss of light transmittance can be minimized while exhibiting the above effect.

While the invention has been particularly shown and described with reference to exemplary embodiments thereof, it will be apparent to those of ordinary skill in the art that various changes in form and detail may be made therein without departing from the spirit and scope of the invention as defined by the following claims.

What is claimed is:

1. A liquid crystal display device comprising:
a lower substrate;
an upper substrate opposite to the lower substrate; and
a liquid crystal layer between the lower substrate and the upper substrate, and comprising a plurality of liquid crystal molecules,
wherein the lower substrate comprises:
an insulating substrate;
a first electrode on the insulating substrate and comprising a first sub-electrode;
an insulating layer on the first electrode;
a second electrode on the insulating layer and comprising a second sub-electrode overlapping the first sub-electrode; and
a third electrode on the insulating layer and comprising a third sub-electrode spaced apart from the first and second sub-electrodes.

2. The liquid crystal display device as set forth in claim 1, wherein the second electrode and the third electrode are disposed in a same layer.

3. The liquid crystal display device as set forth in claim 1, wherein a first-direction width of the first sub-electrode is greater than a first-direction width of the second sub-electrode and a first-direction width of the third sub-electrode.

4. The liquid crystal display device as set forth in claim 3, wherein the first-direction width of the first sub-electrode is smaller than a first-direction distance between the second sub-electrode and the third sub-electrode.

5. The liquid crystal display device as set forth in claim 3, wherein first-direction opposing edges of the second sub-electrode overlap the first sub-electrode.

6. The liquid crystal display device as set forth in claim 1, wherein
the first electrode and the third electrode are applied with a first voltage, and
the second electrode is applied with a second voltage different from the first voltage.

7. The liquid crystal display device as set forth in claim 6, wherein the first electrode and the third electrode are electrically connected to each other.

8. The liquid crystal display device as set forth in claim 6, wherein
a first electric field is generated by the first sub-electrode applied with the first voltage and the second sub-electrode applied with the second voltage,
a second electric field is generated by the second sub-electrode applied with the second voltage and the third sub-electrode applied with the first voltage, and
the liquid crystal molecules are aligned in a direction substantially parallel to the lower substrate by the first electric field and the second electric field.

9. The liquid crystal display device as set forth in claim 8, wherein
the first electric field is greater than the second electric field, and
the alignment of the liquid crystal molecules is determined by the first electric field when a low grayscale image is displayed.

10. The liquid crystal display device as set forth in claim 1, wherein
the first electrode is applied with a first voltage, and
the second electrode and the third electrode are applied with a second voltage different from the first voltage.

11. The liquid crystal display device as set forth in claim 10, wherein the second electrode and the third electrode are a single, unitary, indivisible member.

12. The liquid crystal display device as set forth in claim 10, wherein
a first electric field is generated by the first sub-electrode applied with the first voltage and the second sub-electrode applied with the second voltage,
a second electric field is generated by the second and third sub-electrodes applied with the second voltage, and
the liquid crystal molecules are aligned in a direction substantially parallel to the lower substrate by the first electric field and the second electric field.

13. The liquid crystal display device as set forth in claim 12, wherein
the first electric field is greater than the second electric field, and
the alignment of the liquid crystal molecules is determined by the first electric field when a low grayscale image is displayed.

14. The liquid crystal display device as set forth in claim 1, wherein
a first-direction first edge of the second sub-electrode overlaps the first sub-electrode, and
a first-direction opposing second edge of the second sub-electrode does not overlap the first sub-electrode.

15. The liquid crystal display device as set forth in claim 14, wherein
the first electrode and the third electrode are applied with a first voltage, and
the second electrode is applied with a second voltage different from the first voltage.

16. The liquid crystal display device as set forth in claim 12, wherein the liquid crystal molecules are positive in dielectric anisotropy.

17. The liquid crystal display device as set forth in claim 16, wherein the liquid crystal molecules are initially aligned in a direction substantially orthogonal to the lower substrate.

18. The liquid crystal display device as set forth in claim 1, wherein the first sub-electrode, the second sub-electrode and the third sub-electrode are provided in plurality, respectively.

19. A liquid crystal display device comprising:
a lower substrate;
an upper substrate opposite to the lower substrate; and
a liquid crystal layer between the lower substrate and the upper substrate, and comprising a plurality of liquid crystal molecules,
wherein the lower substrate comprises:
an insulating substrate;
a first electrode on the insulating substrate, and comprising a first sub-electrode elongated in a second direction;
an insulating layer on the first electrode;
a second electrode on the insulating layer, and comprising a second sub-electrode overlapping the first sub-electrode and elongated in the second direction; and
a third electrode on the insulating layer, and comprising a third sub-electrode elongated in the second direction and spaced apart from the first and second sub-electrodes in a first direction crossing the second direction.

20. The liquid crystal display device as set forth in claim 19, wherein
a first electric field generated between the first and second sub-electrodes by respective voltages applied to the first and second sub-electrodes is greater than a second electric field generated between the second and third sub-electrodes by respective voltages applied to the second and third sub-electrodes, and
the alignment of the liquid crystal molecules is determined by the first electric field when a low grayscale image is displayed on the liquid crystal display device.
